(19) United States
(12) Patent Application Publication
(10) Pub. No.: US 2013/0283906 A1
(43) Pub. Date: Oct. 31, 2013

(54) FLUID LEVEL SENSOR APPARATUS

(71) Applicant: Edward Jelonek, Kent (GB)

(72) Inventor: Edward Jelonek, Kent (GB)

(73) Assignee: AVELEC LIMITED, Kent (GB)

(21) Appl. No.: 13/978,253

(22) PCT Filed: Dec. 21, 2011
(86) PCT No.: PCT/GB11/01746

§ 371 Date: Jul. 3, 2013

(30) Foreign Application Priority Data
Jan. 4, 2011 (GB) GB 1100044.5

(51) Int. Cl. G01F 23/26

(52) U.S. Cl. CPC G01F 23/263
USPC 73/304 C

(57) ABSTRACT

A fluid level sensor apparatus with zero thermal shift and auto calibration is provided, the sensor apparatus comprising a measurement probe, a base probe and a processor; wherein each probe includes a reference electrode in contact in use with the fluid, the base probe further including a dry electrode and the measurement probe further including a wet electrode and wherein the processor is adapted to measure the capacitance of the two probes and calculate the fluid level according to a pre-determined algorithm.

The present invention relates to precision fluid level sensors in general and, in particular, to fluid level sensors for use in vehicle fuel tanks.

Simple capacitive fluid level sensors are known. Typically, they comprise an outer cylinder forming a first electrode and an inner, coaxial rod-like electrode. Such a sensor is located vertically within a fuel tank and the fuel is allowed to enter the annular gap between the electrodes. The fuel causes the capacitance of the pair of electrodes to change substantially linearly with the fluid depth according to the equation:

Cₜ=Cₐ+C_{f}

where Cₜ is the total sensor capacitance, Cₐ is the dry tank sensor capacitance and C_{f} is the fluid capacitance contribution.

The fluid capacitance contribution C, varies with the relative permittivity of the fluid according to the following equation:

C_{f}=Cₐ(K−1)

where K is the relative permittivity of the fluid.

Once the sensor is calibrated and an accurate fluid depth is obtained, then the volume of fuel within the tank can be calculated from a table of depth versus volume for the relevant tank and this can be normalised to a suitable reference temperature.

Such sensors have problems associated with them. For example, if the fuel within the tank is replaced with a fuel having a somewhat different relative permittivity, owing, for example, to a different amount or type of an additive or a change to different type of fuel (e.g. changing from regular diesel to a biofuel), then the calculation of the amount of fuel remaining in the tank will be incorrect. Thus, if a fuel B is replaced with a different fuel C, then the measured fluid only capacitance contribution C_{f}(c) for any depth is:

C_{f}(c)=C_{f}(b)×[(Kc−1)/(Kb−1)]

Wherein C_{f}(b) is the fluid capacitance contribution of fuel B, Kb is the relative permittivity of fuel B and Kc is the relative permittivity of fuel C.

In addition, such sensors tend to be normalised to a suitable reference temperature. However, if the temperature changes over time without any further calibration(s) being made, then the total of the non-fluid hardware and measuring electronics capacitance contributions may change. This is due to the changed temperature gradient along the length of the probe and the temperature change of the measuring electronics. An accurate figure for the sum of these non-fluid capacitances must be known across a temperature range in order to calculate accurately the fluid volume within a tank for any given temperature.

Experience with motor racing oil level sensors has shown that a temperature change for the oil of a racing car to be in excess of 100° C. is not uncommon. Consequently, such sensors need to be calibrated near to their expected operating temperatures in order to compensate for this variation. Such calibration is difficult to conduct and the temperature changes can vary from track to track and from country to country.

Furthermore, vehicles often re-circulate hot fuel back into the tank from a fuel pump and/or injector system, which in turn can lead to variable temperature gradients along the length of the probe and thus vary the non-fluid capacitances. In addition, some or all of the measurement electronics may be outside of the tank and therefore at a different temperature to the fuel within the tank.

US 2008/066544 discloses generally the use of a reference capacitor as part of a capacitive sensor. However, details of the sensors are not provided.

The present invention seeks to address at least some of the above-mentioned problems associated with conventional fluid level sensors.

According to a first aspect of the invention, there is provided a fluid level sensor apparatus comprising a measurement probe, a base probe and a processor; wherein each probe includes a reference electrode in contact in use with the fluid, the base probe further including a dry electrode and the measurement probe further including a wet electrode and wherein the processor is adapted to measure the capacitance of the two probes and calculate the fluid level according to a pre-determined algorithm.

The use of a base probe in this way allows the processor to subtract most, if not all, of the non-fluid capacitances to determine the fluid capacitance contribution. From this and the original calibration data, the processor can determine accurately the volume of the fluid present in a tank. In particular, by having the reference electrode for both the base probe and the measurement probe in contact with the fluid in use, the variations in capacitance caused by temperature differentials are able to be subtracted from the measurements produced by the measurement probe. Thus, the apparatus of the present invention requires significantly fewer calibrations to ensure accurate results. This is because the apparatus of the present apparatus can effectively be calibrated “in use”.

It will be appreciated that the dry electrode of the base probe is insulated or isolated from the fluid within the tank to measure the non-fluid capacitance contribution, whereas the wet electrode of the measurement probe is in contact with the fluid to measure the fluid capacitance contribution.

In this way, the measurement probe may be effectively calibrated for the tank conditions while the vehicle is moving.

In an embodiment of the invention, the measurement probe reference electrode and the base probe reference electrode are defined by a common electrode. In this embodiment, the common reference electrode may, for example be defined by the tank itself, where the tank is formed from a metal or other conductive material. In such an embodiment, the wet electrode of the measure probe may be located within the tank and the dry electrode of the base probe may be located outside of the tank. Alternatively, the reference electrode may be in the form of a conductive housing adapted to be located within the tank and within which are located the wet electrode of the measurement probe in a first compartment and the dry electrode of the base probe in a second compartment.

In an alternative embodiment, the measurement probe and the base probe each include a separate respective reference electrode. In this embodiment, each of the two probes is a separate, stand-alone component which may facilitate the siting of the probes within a tank.

Suitably, in an embodiment where the probes are separate components, the reference electrode may be arranged coaxially around the wet or dry electrode. Thus, the reference electrode of the base and/or measurement probe may form a cylindrical housing within which is axially located the wet or dry electrode. Such an arrangement provides a compact arrangement for the probe(s) which provides accurate and reproducible capacitance measurements.

In an embodiment of the invention, the reference electrode of the measurement probe is in the form of a cylinder and includes a fluid inlet port at one end thereof and a fluid outlet port at the opposite end thereof. Such an arrangement allows the fluid to enter the cylinder defined by the reference electrode and contact the wet electrode. By controlling the dimensions of the cylinder and/or the inlet/outlet ports, the probe can minimise the variability in its measurements caused by fluid moving within the tank, e.g. when the tank is fitted to a moving vehicle.

In particular, if the gap defined between the reference electrode and the wet electrode in the measurement probe is relatively small, then the rate of change of the fuel level within the probe will be less than the fuel within the remainder of the tank as the fuel moves about within the tank as a result of vehicle movement. Similarly, if the input and/or output ports are relatively small, then flow of the fuel into or out of the probe is limited, providing a baffle effect which minimises the rate of change of the fuel level with vehicle movement.

The skilled person will appreciate that in the embodiment described above, the level (and therefore the volume) of the fuel remaining in the tank will directly correlate with the level of the fuel within the measurement probe cylinder, which is measured by the measurement probe.

As mentioned above, the relative permittivity of a fuel depends upon the nature of the fuel and the additives that are included with the fuel. If the fuel being used is changed, for example by changing from a diesel fuel to a biofuel, then the measurement probe may provide inaccurate readings as the remaining fuel mixes with the new fuel, resulting in a non-homogeneous mixture within the measurement probe. In order to prevent such inaccuracies, the measurement probe may include a pump adapted to purge the probe of fluid, the probe being adapted such that when the pump is energised, the fluid outlet port may be closed, whereby the fluid is ejected from the probe via the inlet port. However, the skilled person will appreciate that if the pump is sufficiently powerful, the fluid outlet port need not be closed in order to purge the sensor. In this way, the probe can be regularly purged and amounts of a previous fuel type removed from the probe, to be replaced by the new fuel type. In this way, the fluid within the probe may be maintained as a homogeneous fluid and the number of re-calibrations needed to produce accurate readings from the probe is reduced.

In an embodiment of the invention, both of the probes are configured with the reference electrode arranged coaxially about the relevant wet and dry electrode and the two probes are arranged adjacent to each other. In this arrangement, the non-fuel readings from the base probe mirror the non-fuel contribution of the measurement probe reading and these can be subtracted from the measurement probe reading to provide an accurate measurement of the fluid level.

Suitably, the measurement probe includes a fluid level switch, more suitably it includes a pair of spaced apart fluid level switches. In such an arrangement, the fluid level switch(es) can be used to calibrate the probe, as the probe can be used to measure the capacitance of a known volume of fuel and thereby the relative permittivity of the fuel can be determined. This can then be used to determine accurately the fluid level in the tank in use.

In embodiments where the measurement probe is used within a relatively deep tank, such as for example a storage tank, then the elongate measurement probe may include more than two fluid level switches.

In an embodiment of the invention, the processor includes a capacitance measurement assembly. This assembly may include a switch such that it can measure the capacitance of the base probe and the measurement probe separately or it may be adapted to measure the capacitance of the probes simultaneously.

The apparatus may include a temperature sensor to measure the temperature of the fluid within the tank.

The processor may include a controller which controls the operation of the apparatus. For example, the controller may control the operation of the measurement switch(es), the pump and/or the ports, where present.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

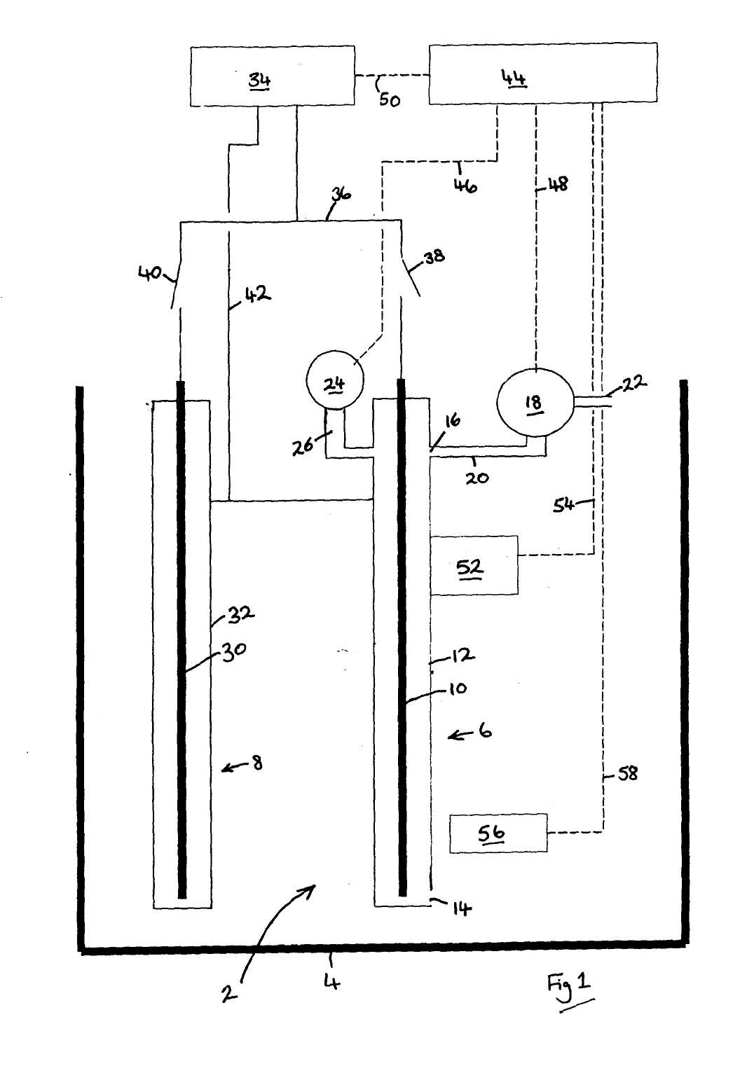

FIG. 1 is a schematic view of a fluid level sensor apparatus installed within a fuel tank.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the FIGURE.

A fluid level sensor apparatus 2 is shown schematically in FIG. 1 fitted within a fuel tank 4. The sensor apparatus 2 includes a measurement probe 6 and a base probe 8.

The measurement probe 6 includes a wet electrode rod 10 housed within a cylindrical housing 12 which defines a measurement probe reference electrode. The measurement probe housing 12 includes an inlet port 14 located at the bottom of the housing 12 and an outlet port 16 located towards the top of the housing 12. The outlet port 16 is in fluid communication with an outlet valve 18 via a conduit 20. An exhaust conduit 22 connects the outlet side of the outlet valve 18 with the interior of the tank 4.

A fluid purge pump 24 is also connected to an upper portion of the housing 12 via a pump conduit 26. The pump 24 includes an air inlet (not shown) adapted to draw air from the interior of the tank 4. The skilled person will, of course, appreciate that the pump 24 may instead include an air inlet adapted to draw air from outside of the tank 4.

The base probe 8 includes a similar arrangement with a dry electrode rod 30 housed within a cylindrical housing 32. However, unlike the measurement probe housing 12, the base probe cylindrical housing 32 is sealed such that fluid within the tank 4 is not able to enter the housing 32 and contact the dry electrode 30. As with the measurement probe 6, the base probe housing 32 defines a base probe reference electrode.

As shown in FIG. 1, the measurement probe 6 and the base probe 8 are arranged adjacent to one another within the tank 4 such that they parallel and vertically level with each other.

The sensor apparatus 2 further includes a set of measurement electronics 34 which are adapted to measure the capacitance of the measurement probe 6 and the base probe 8. The measurement electronics 34 are connected to the wet electrode 10 via a common connector 36 and a switch 38, and they are connected to the dry electrode 30 via the common connector 36 and a switch 40. The measurement electronics 34 are also connected to the measurement probe reference electrode 12 and the base probe reference electrode 32 via a reference electrode common connector 42, which connects the two reference electrodes 12, 32 to each other as well as the measurement electronics 34. The skilled person will appreciate that the two reference electrodes 12, 32 need not be electrically connected on a permanent basis. They could, for example, be connected via switches (not shown) in a way similar to the connection of the wet and dry electrodes 10, 30.

The measurement electronics 34 are standard components used to measure capacitance which are well known to those skilled in the art of capacitance measurement and as such will not be described in detail herein.

The switches 38, 40 are controlled by a controller (not shown) which forms part of a processor 44. The controller ensures that only one of the switches 38, 40 is closed at any given time such that the measurement electronics 34 measures either the capacitance of the measurement probe 6 or the base probe 8 individually. Of course, the skilled person will appreciate that alternative embodiments may provide for the capacitance of the measurement probe 6 and the base probe 8 to be measured simultaneously.

The controller also controls the operation of the purge pump 24 via a control cable 46 and the operation of the outlet valve 18 via a control cable 48.

The processor 44 is connected to the measurement electronics via a data cable 50 such that capacitance measurements for the measurement probe 6 and the base probe 8 are provided to the processor 44. Of course, in an alternative embodiment (not shown), the processor 44 may be intimately connected to the measurement electronics, for example they may both form part of a printed circuit board or the like. The processor 44 also receives data from a fluid level switch 52 via a connector 54 and from a temperature sensor 56 via a connector 58.

In use, the measurement probe 6 is first purged of fluid by the controller energising the pump 24 whilst the outlet valve 18 is closed. This forces the fluid within the housing 12 to be ejected via the inlet port 14.

After purging, the switch 38 is closed, then the pump 24 is then switched off and the outlet valve 18 is opened to allow fluid to enter the measurement probe housing 12 via the inlet port 14. When the fluid reaches the fluid level switch 52, a calibration measurement of the fuel only capacitance is stored by the processor. This is achieved by subtracting the dry probe capacitance from the wet probe capacitance.

The relative permittivity of the fluid can then be calculated for the fluid based on the calculated fluid capacitance contribution and the known volume dictated by the fluid level switch 52.

From the calculated relative permittivity of the fluid within the tank 4, the volume of fluid remaining within the tank 4 can be monitored by the measurement probe 6 according to pre-determined algorithms which correlate fluid capacitance contribution to fluid volume within the tank 4.

Subsequent physical changes within the tank 4, such as temperature gradients along the probes 6, 8 can be excluded from the measurements by subtracting the non-fluid capacitance contribution measured by the base probe 8 from the measurements made using the measurement probe 6.

1. A fluid level sensor apparatus comprising a measurement probe, a base probe and a processor; wherein each probe includes a reference electrode in contact in use with the fluid, the base probe further including a dry electrode and the measurement probe further including a wet electrode and wherein the processor is adapted to measure the capacitance of the two probes and calculate the fluid level according to a pre-determined algorithm.

2. (canceled)

3. A fluid level sensor apparatus according to claim 1, wherein the measurement probe and the base probe each include a separate respective reference electrode.

4. A fluid level sensor apparatus according to claim 3, wherein the reference electrode of the measurement probe is arranged coaxially about the wet electrode.

5.-9. (canceled)

10. A fluid sensor apparatus according to claim 3, wherein the measurement probe includes a fluid level switch.

11. A fluid level sensor apparatus according to claim 3, wherein the processor includes a capacitance measurement assembly.

12. A fluid level sensor apparatus according to claim 4, wherein the reference electrode is in the form of a cylinder and includes a fluid inlet port at one end thereof and a fluid outlet port at the opposite end thereof.

13. A fluid level sensor apparatus according to claim 4, wherein the reference electrode of the base probe is arranged coaxially about the dry electrode and the two probes are arranged adjacent to each other.

14. A fluid sensor apparatus according to claim 4, wherein the measurement probe includes a fluid level switch.

15. A fluid level sensor apparatus according to claim 4, wherein the processor includes a capacitance measurement assembly.

16. A fluid level sensor apparatus according to claim 12, wherein the measurement probe further includes a pump adapted to purge the probe of fluid, the probe being adapted such that when the pump is energized, the fluid outlet port is closed, whereby the fluid is ejected from the probe via the inlet port.

17. A fluid level sensor according to claim 12, wherein the reference electrode of the base probe is arranged coaxially about the dry electrode and the two probes are arranged adjacent to each other.

18. A fluid level sensor apparatus according to claim 12, wherein the probe includes a fluid level switch.

19. A fluid level sensor apparatus according to claim 12, wherein the processor includes a capacitance measurement assembly.

20. A fluid level sensor apparatus according to claim 16, wherein the reference electrode of the base probe is arranged coaxially about the dry electrode and the two probes are arranged adjacent to each other.

21. A fluid level sensor apparatus according to claim 16, wherein the measurement probe includes a fluid level switch.

22. A fluid level sensor apparatus according to claim 16, wherein the processor includes a capacitance measurement assembly.

23. A fluid level sensor apparatus according to claim 1, wherein the measurement probe reference electrode and the base probe reference electrode are defined by a common electrode.

24. A fluid level sensor apparatus according to claim 23, wherein the measurement probe includes a fluid level switch.

25. A fluid level sensor apparatus according to claim 23, wherein the processor includes a capacitance measurement assembly.

26. A fluid level sensor apparatus according to claim 1, wherein the measurement probe includes a fluid level switch.

27. A fluid level sensor apparatus according to claim 26, wherein the processor includes a capacitance measurement assembly.

28. A fluid level sensor apparatus according to claim 1, wherein the processor includes a capacitance measurement assembly.
